(19) United States
(12) Patent Application Publication
(10) Pub. No.: US 2016/0186913 A1
(43) Pub. Date: Jun. 30, 2016

(54) WATER HOSE COVERING ASSEMBLY

(71) Applicant: Steven Schatz, St Marys, PA (US)

(72) Inventor: Steven Schatz, St Marys, PA (US)

(21) Appl. No.: 14/587,145

(22) Filed: Dec. 31, 2014

(51) Int. Cl. F16L 55/16; F16L 11/20

(52) U.S. Cl. CPC F16L 55/1604; F16L 11/20

(57) ABSTRACT

A water hose covering assembly for capturing water from a ruptured water hose includes a pair of hoses that each may direct a flow of fluid. A pair of tubes each houses one of the hoses and contains the fluid if the either of the hoses rupture. A conduit extends between and is fluidly coupled to each of the tubes. A drain is fluidly coupled to the conduit and disposes of the fluid when one of the hoses ruptures.

### BACKGROUND OF THE DISCLOSURE

1. Field of the Disclosure

The disclosure relates to hose covering devices and more particularly pertains to a new hose covering device for capturing water from a ruptured water hose.

2. Summary of the Disclosure

An embodiment of the disclosure meets the needs presented above by generally comprising a pair of hoses that each may direct a flow of fluid. A pair of tubes each houses one of the hoses and contains the fluid if the either of the hoses rupture. A conduit extends between and is fluidly coupled to each of the tubes. A drain is fluidly coupled to the conduit and disposes of the fluid when one of the hoses ruptures.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a water hose covering assembly according to an embodiment of the disclosure.

FIG. 2 is a cross sectional view taken along line 2-2 of figure of an embodiment of the disclosure.

FIG. 3 is an in-use view of an embodiment of the disclosure.

### DESCRIPTION OF THE PREFERRED EMBODIMENT

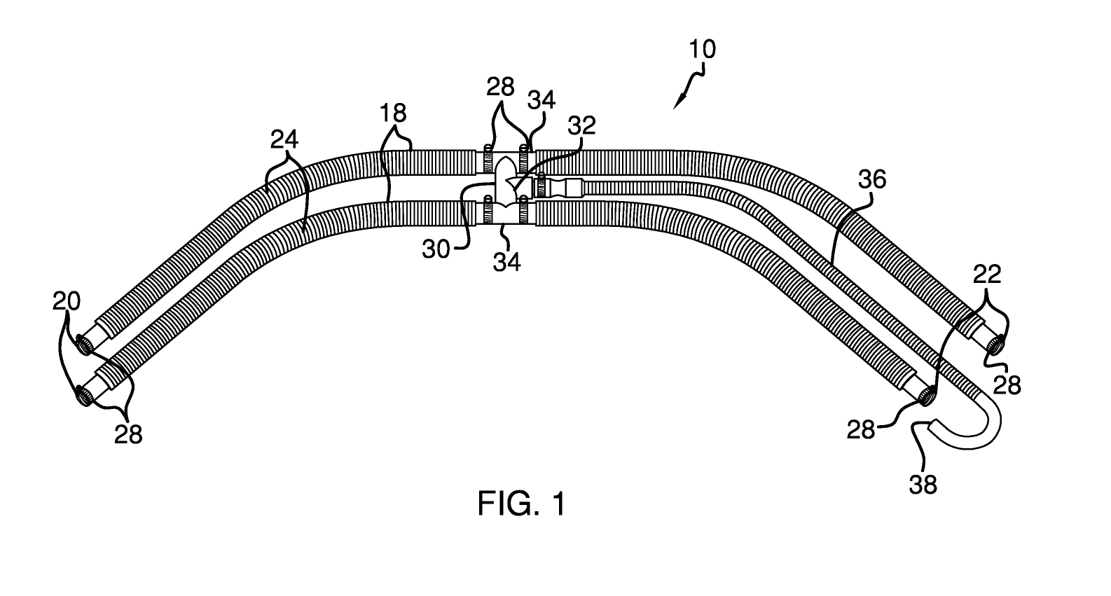

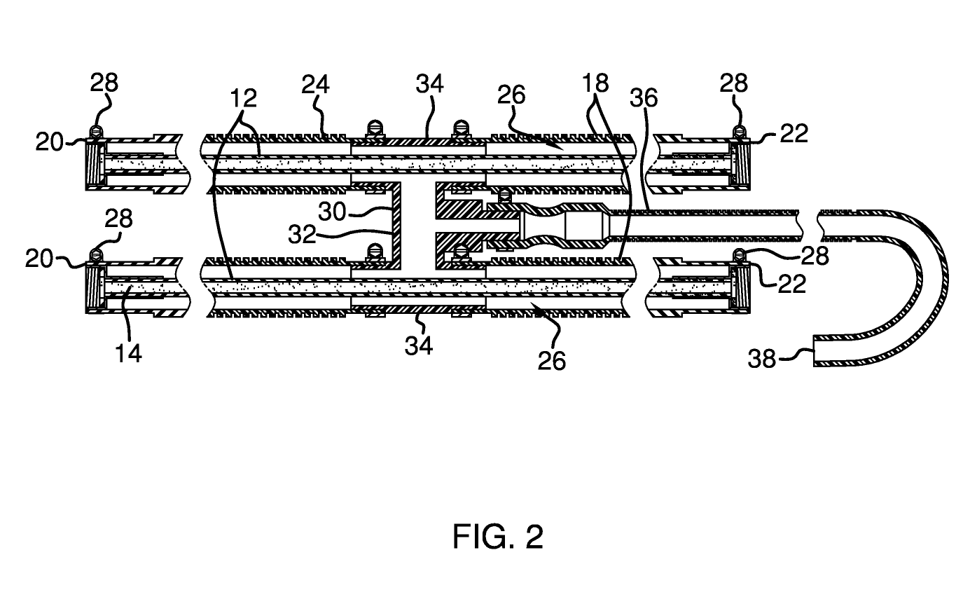

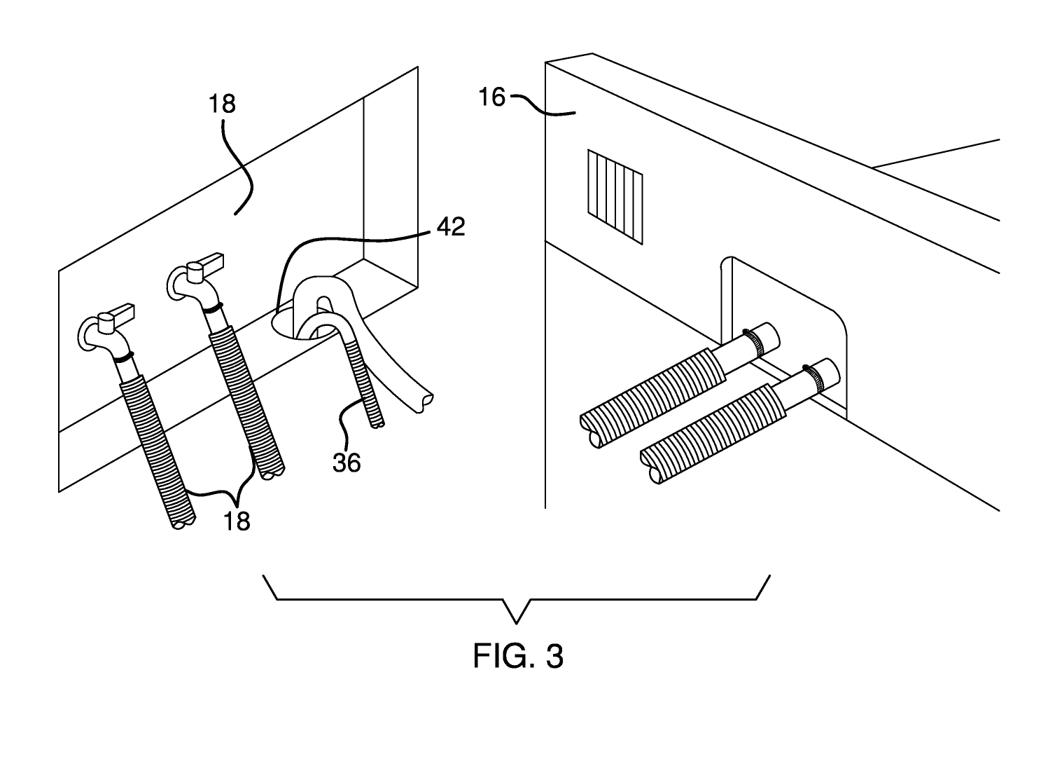

With reference now to the drawings, and in particular to FIGS. 1 through 3 thereof, a new hose covering device embodying the principles and concepts of an embodiment of the disclosure and generally designated by the reference numeral 10 will be described.

As best illustrated in FIGS. 1 through 3, the water hose covering assembly 10 generally comprises a pair of hoses 12. Each of the hoses 12 may each direct a flow of fluid 14. The fluid 14 may be water. Additionally, each of the hoses 12 may direct the fluid 14 into an appliance 16 positioned within a building 18. The appliance 16 may be a washing machine or the like.

A pair of tubes 18 is provided. Each of the tubes 18 has a first end 20, a second end 22 and a peripheral wall 24 extending therebetween. Each of the tubes 18 houses one of the hoses 12 such that the tubes 18 are each substantially coextensive with the hoses 12. Each of the peripheral walls 24 is spaced from the hoses 12 to define a fluid space 26 between the peripheral walls 24 and the hoses 12. The fluid space 26 contains the fluid 14 if the either of the hoses 12 rupture.

A plurality of clamps 28 is each positioned around the tubes 18. The clamps 28 are positioned adjacent an associated one of the first ends 20 and the second ends 22. The clamps 28 tighten the tubes 18 around the hoses 12. Moreover, the clamps 28 prevent the fluid 14 from escaping the tubes 18. The clamps 28 may be hose clamps or the like.

A conduit 30 is provided. The conduit 30 extends between and is fluidly coupled to each of the tubes 18. The conduit 30 may include a central section 32 fluidly coupled to and extending between a pair of lateral sections 34. The lateral sections 34 may be oriented transverse to the central section 32. The lateral sections 34 may each be fluidly coupled to one of the tubes 18. Additionally, the conduit 30 may be centrally positioned on the tubes 18.

A drain 36 is fluidly is coupled to the conduit 30. The drain 36 has a distal end 38 with respect to the conduit 30. The drain 36 may be curved adjacent to the distal end 38, giving the drain 36 a J-shape. The distal end 38 may be positioned within a fluid drain 42 such that the fluid 14 is directed into the fluid drain 42 when one of the hoses 12 ruptures. The drain 36 may be fluidly coupled to the central section 32.

In use, the tubes 18 are positioned over the hoses 12 to protect the building from fluid damage if one of the hoses 12 ruptures. The drain 36 continuously directs the fluid 14 into the fluid drain 42 until a flow of the fluid 14 is stopped. The tubes 18 are removed from the hoses 12 to facilitate the hose 12 that has rupture being repaired or replaced.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A water hose covering assembly configured to direct water into a drain when the water hose fails, said assembly comprising:
a pair of hoses each configured to direct a flow of fluid;
a pair of tubes each housing one of said hoses and being configured to contain the fluid if said either of said hoses rupture;
a conduit extending between and being fluidly coupled to each of said tubes; and
a drain fluidly coupled to said conduit and disposing of the fluid when one of said hoses ruptures.

2. The assembly according to claim 1, wherein having a first end, a second end and an peripheral wall extending therebetween, each of said tubes housing one of said hoses such that said tubes are each substantially coextensive with said hoses, each of said peripheral walls being spaced from said hoses to define a fluid space between said peripheral walls and said hoses.

3. The assembly according to claim 2, wherein a plurality of clamps each positioned around said tubes, said clamps being positioned adjacent an associated one of said first ends and said second ends, said clamps tightening said tubes around said hoses, said clamps preventing the fluid from escaping said tubes.

4. The assembly according to claim 1, wherein said drain having a distal end with respect to said conduit, said distal end being configured to be positioned within a fluid drain such that the fluid is directed into the fluid drain when one of said hoses ruptures.

5. A water hose covering assembly configured to direct water into a drain when the water hose fails, said assembly comprising:
a pair of hoses each configured to direct a flow of fluid;
a pair of tubes each having a first end, a second end and an peripheral wall extending therebetween, each of said tubes housing one of said hoses such that said tubes are each substantially coextensive with said hoses, each of said peripheral walls being spaced from said hoses to define a fluid space between said peripheral walls and said hoses, said fluid space being configured to contain the fluid if said either of said hoses rupture;
a plurality of clamps each positioned around said tubes, said clamps being positioned adjacent an associated one of said first ends and said second ends, said clamps tightening said tubes around said hoses, said clamps preventing the fluid from escaping said tubes;
a conduit extending between and being fluidly coupled to each of said tubes;
a drain fluidly coupled to said conduit, said drain having a distal end with respect to said conduit, said distal end being configured to be positioned within a fluid drain such that the fluid is directed into the fluid drain when one of said hoses ruptures.
